(19) United States
(12) Patent Application Publication
(10) Pub. No.: US 2006/0080181 A1
(43) Pub. Date: Apr. 13, 2006

(54) System for and method of generating sales proposals and contracts

(76) Inventors: Curtis T. Fernandes, Corona, CA (US); Gina Marie McLaren, Laguna Niguel, CA (US); Robert T. Ellis, Dana Point, CA (US)

Correspondence Address: FISH & RICHARDSON, PC, P.O. BOX 1022, MINNEAPOLIS, MN, 55440-1022, US

(21) Appl. No.: 10/963,778

(22) Filed: Oct. 12, 2004

(51) Int. Cl. G06Q 30/00

(52) U.S. Cl. 705/26

(57) ABSTRACT

Provided is a system for and method of generating sales proposals and contracts. The system comprises a computer, including a proposal generator program, a local sales policy file, and an unspecified number of sales proposals; a second computer, including a contract generator program, a master sales policy file, and an unspecified number of sales contracts; a communication network and a customer information database. A sales policy file can be downloaded. After negotiating with a customer, the system generates a proposal, determines whether the proposal is accepted by the customer, sends the proposal to a home office, determines whether the proposal is accepted by a manager, generates a contract, and updates a customer information database.

### TECHNICAL FIELD

The disclosure relates to sales proposals and contract generation. More particularly, the disclosure relates to creating, maintaining, and sharing sales information in a single, consistent format across a variety of processes used to create materials for business transactions.

### BACKGROUND

A high-quality sales force has always been a key factor in client and revenue generation for many different businesses. While technological advances in computing and telecommunications have made it possible for a sales force to work from almost anywhere in the world, many businesses find it difficult or impossible to replace the personal interaction involved in face-to-face sales. As a result, many salespersons continue to travel to customer locations, trade shows, or conventions in order to generate sales.

The nature of traveling sales is such that, traditionally, a Salesperson who is on the road more often, has better sales success. However, Salespersons regularly check in with, or often return to, their home office. Because of the amount they travel, there is often a time delay involved with receiving information from the home office.

Therefore, when decisions or policies are made by sales managers, there may be a window of time in which the sales force is not aware of, and as a result, not operating under current policies. For example, if the minimum floor price that a salesperson should accept for a sale is increased, he or she may continue to sell at lower, previously accepted price until the new sales information is communicated to the salesperson. Even when sales policy information is communicated to the sales force, the salesperson might forget or even ignore the new policies, because of a “special deal” they would like to give to the customer.

### SUMMARY

As a result of the difficulties described above, what is needed is a means of providing the most accurate, up-to-date sales policy information to a sales force and ensuring the use of that information. The disclosure provides methods and computer implemented methods that provide an automated means of generating certain sales materials, such as a sales proposal and doing so by relying on existing customer information. The disclosed methods also enables the person responsible for offering the business proposal is providing terms and conditions to the customer that reflect current sales policies, as established by some central authority. Furthermore, the disclosed methods provides a method for seamlessly integrating the data generated in the business proposal into other processes, such as billing.

The disclosure provides methods that may decrease the time it takes for a salesperson to generate a sales proposal.

The methods of the disclosure may also provide up-to-date information to a sales force, and enforce the use of, the most accurate, up-to-date sales policy information.

In addition, the methods of the disclosure may improve the turnaround cycle for a reviewing sales manager or other authorizing entity to send a sales proposal document or contract back to a salesperson.

Furthermore, the methods may automatically reflect terms of a sales contract in billing or other related applications based upon the sales contract.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 illustrates a high-level functional diagram of a system for sales proposal and contract generation.

FIG. 2 illustrates a flow diagram of a method of generating a sales contract.

Like reference symbols in the various drawings indicate like elements.

### DETAILED DESCRIPTION

As used herein and in the appended claims, the singular forms “a,” “and,” and “the” include plural references unless the context clearly dictates otherwise.

Unless defined otherwise, all technical and scientific terms used herein have the same meaning as commonly understood to one of ordinary skill in the art to which this disclosure belongs. Although any methods and reagents similar or equivalent to those described herein can be used in the practice of the disclosed methods and compositions, the exemplary methods and materials are now described.

The disclosure provides a system for and method of using a sales proposal and contract generation application. A salesperson or other user automatically generates a sales proposal that meets current sales policies established by a sales department, company, or other authorizing entity. The sales proposal is then sent to and approved by a sales manager or other authorizing entity. Upon approval, a sales contract is automatically generated, and specifics of the contract are updated in a centralized database for use with other applications.

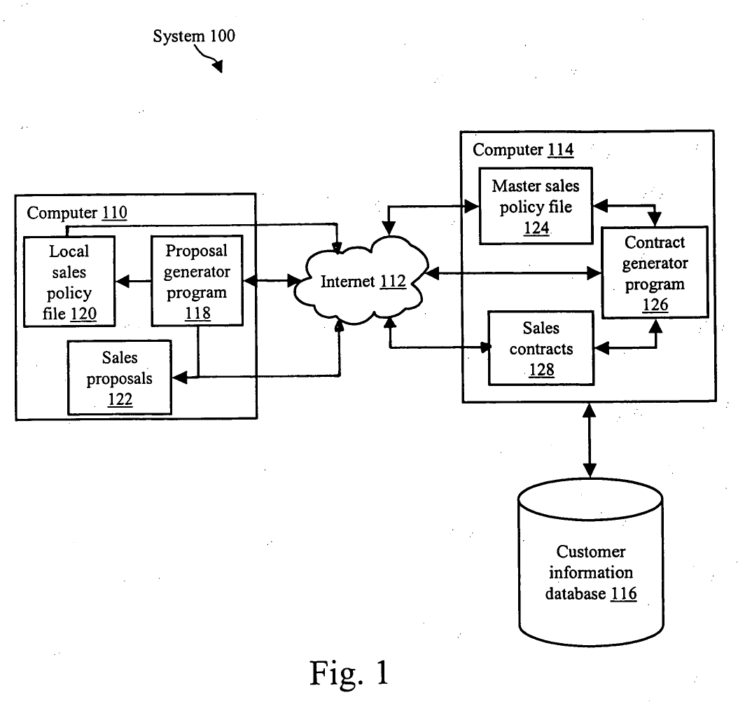

FIG. 1 illustrates a high-level functional diagram of a system 100 for sales proposal and contract generation. System 100 includes a computer 110, a communication medium or network (e.g., the Internet) 112, a computer 114, and a customer information database 116. Computer 110 comprises a proposal generator program 118, a local sales policy file 120, and a sales proposal or a plurality of sales proposals 122. Computer 114 comprises a master sales policy file 124, a contract generator program 126, and a sales contract or plurality of sales contracts 128.

Computer 110 is representative of any conventional or special-purpose computer that has a display, such as a desktop, laptop, or server computer. Typically, computer 110 is a laptop computer used by salespersons during travel at customer sites, trade shows, or other locations for generating sales. Computer 110 contains proposal generator program 118, which is a software program used for inputting customer-specific sales information and outputting proposals. As a salesperson interacts with current or potential customers, the sales person can create a sales proposal in response to the customer and sales-force information. First, the user selects “create sales proposal” from a menu of functions available in the proposal generator program 118. Proposal generator 118 comprises a Graphical User Interface (GUI) comprising a number of fields for entry of data. The number of fields will depend upon the nature of the business and customer specific information that is needed.

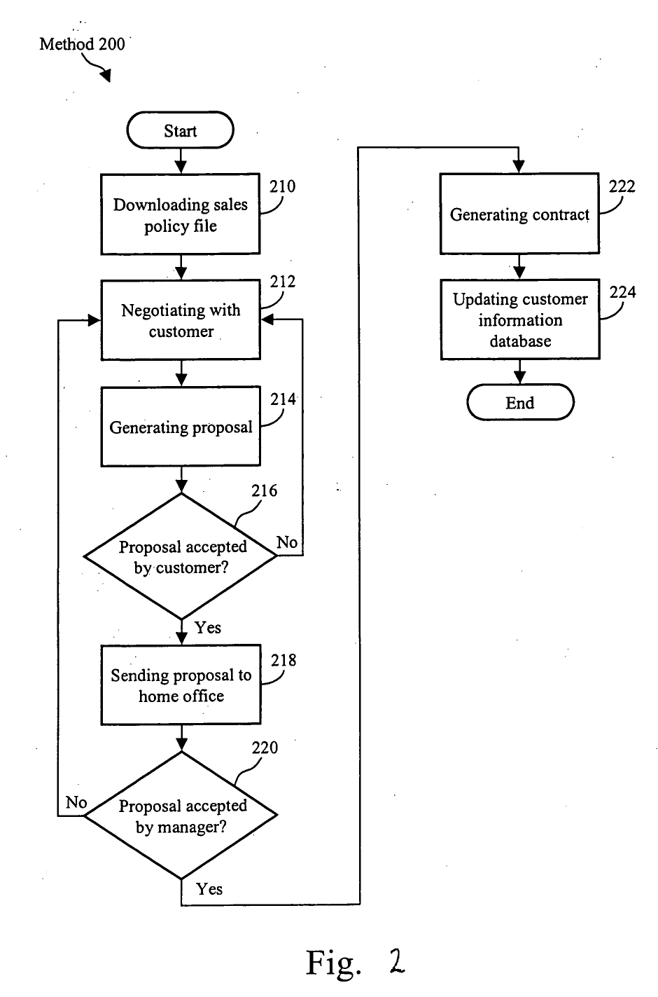

After the salesperson chooses to create a sales proposal, the user enters information including, for example, a sales price and sales/vendor terms, into a GUI of proposal generator program 118. The sales/vendor terms may include payment terms, payment mode, bank payment data, delivery terms, taxes, product delivery mode, vendor's warehouse location, term of proposal delivery, term of contract validity, and other terms necessary for completing a sales transaction. These sales/vendor terms are pre-programmed and regularly updated from the master sales policy file 124 to the local sales policy file 120 and automatically generated and entered in through proposal generator program 118 and ultimately present in sales proposals 122. When sales prices and terms have been entered, the sales proposal is sent to the customer for review (see, e.g., FIG. 2, step 216).

Proposal generator program 118 generates sales proposal(s) 122 by using a combination of user-entered, customer-specific information and default, sales/vendor information. In one embodiment, sales proposal(s) 122 are generated in either extensible markup language (XML) and/or word processing document formats. Those skilled in the art will appreciate that proposal generator program 118 could be written to output sales proposals 122 in a variety of other document formats. However, the XML format is useful for sharing sales proposal data from sales proposal(s) 122 with other computers and/or software programs. A word processing document is a typical format for printing sales proposal(s) 122.

The terms of sale offered or accepted by a sales force should typically meet current sales policies. For example, if a sales manager raises the minimum floor price for a sale, a salesperson should not be able to create a sales proposal 122 by using proposal generator program 118 for which the previously lower minimum floor price is used. The current sales policies are reflected in local sales policy file 120. Formats other than extensible markup language (XML) document could also be used in this disclosure. The local sales policy file 120 is kept separate from proposal generator program 118. This allows a separate entity, such as a sales manager at a head office, to update current sales policies in master sales policy file 124. The master sales policy file 124 is distributed to salespersons and stored in local sales policy file 120. Examples of sales/vendor data in local sales policy file 120 may include pricing structure options (e.g., purchase price, per click, operating lease, capital lease) and floor prices for an entire system, peripherals, custom software, or additional offerings from the selling company. Other sales/vendor data may include payment terms, payment mode, bank payment data delivery terms, taxes, product delivery under vendor's warehouse location, term of proposal delivery, term of contract validity, and the like. Each salesperson accesses current sales policies by downloading master sales policy file 124 via communications medium or network (e.g., Internet) 112. Proposal generator program 118 reads information contained within local sales policy file 120. Specific sales options or entries in proposal generator program 118 are enabled, disabled, and/or limited, based on contents of local sales policy file 120. This dictates control through local sales policy file 120.

Computer 114 is representative of any conventional or special-purpose computer that has a display, such as a desktop, laptop, or server computer. Typically, computer 114 is a desktop computer that resides at a sales manager's office. Computer 114 contains contract generator program 126, which is a software program used for viewing and editing sales proposals 122 and turning acceptable proposals 122 into sales contracts 128. More specifically, contract generator program 126 reads and interprets the XML format of the sales proposals 122 that are generated by proposal generator program 118. Contract generator program 126 allows a user to make changes and/or additions to sales proposals 122 using the software GUI. Upon reviewing and accepting each sales proposal 122, contract generator program 126 also turns sales proposals 122 into sales contracts 128 in XML format and word processing document format. Sales contracts 128 are sent back to computer 110 via communications medium 112.

In operation, current sales policies are maintained by a sales manager using computer 114 in a master sales policy file 124. Salespersons access master sales policy file 124 and, via communications medium 112, download a copy to computer 110 as local sales policy file 120. The file is updated as often as necessary. Salespersons use proposal generator program 118 to input customer sales information and output sales proposals 122. Sales proposals are then sent to sales managers for approval via communication medium 112. Sales managers use contract generator program 126 to review sales proposals 122 and output sales contracts 128. Data established in sales contracts 128 is also updated in customer information database 116 for use by other business processes.

Customer information database 116 is in communication with computer 114 and is representative of a centralized database in which a variety of current customer information is stored. Examples of customer information include the name, address, and telephone number of each customer, primary contact, and billing specifics, as agreed upon by the customer's sales contract 128. Data within customer information database 116 can be accessed and utilized by a multitude of other computers in addition to computer 114.

Upon acceptance of a sales proposal 122 and generation of a sales contract 128 for a customer, contract generator program 126 commands either the creation of a new customer entry or the updating of an existing customer entry within customer information database 116. Prior to this function, sales contract 128 information is only stored in a local file on computer 114 and computer 116. The contract data updates database 116 so that additional applications, such as billing, can access the same agreed-upon information in each customer's sales contract 128.

FIG. 2 illustrates a flow diagram 200 of generating a sales contract. This flow chart can be executed on a computer, e.g., as previously described.

At 210, a salesperson obtains the latest master sales policy file 124. The salesperson may automatically download the file via communication medium 112 by using the application functionality of proposal generator program 118, another conventional file transfer method, such as file transfer protocol (FTP), or by transferring via e-mail. A copy of the master sales policy file 124 is saved to computer 110 as local sales policy file 120 and placed in the appropriate location, where proposal generator program 118 looks for it.

At 212 the salesperson negotiates specific terms and conditions of a sale with a customer.

At 214 the salesperson enters sale terms and conditions, such as sales rep, customer, billing, service agreement, and licensed software information, into proposal generator program 118. Sales information is verified against current sales policies, as documented in local sales policy file 120. A sales proposal 122 is then generated in either or both of word processing and XML document formats.

In decision 216, the word processing document version of the sales proposal 122 is given to the customer for review and, subsequently, either accepted or rejected by the customer. If yes, flow 200 proceeds to 218. If no, flow 200 returns to 212.

At 218 the XML sales proposal 122 file is transferred via communication medium 112 to a sales manager or other user who is responsible for authorizing each sales proposal. While the most common method of transfer is a conventional e-mail application, transfer methods that use the application functionality of proposal generator program 118 and contract generator program 126 could also be used.

At 220 the sales manager opens contract generator program 126, reviews and edits sales proposal 122, and ultimately decides whether to accept sales proposal 122. If yes, flow 200 proceeds to 222. If no, flow 200 returns to 212.

When sales proposal 122 is accepted, sales contract 128 is then generated 222 in both word processing and XML document formats. Both documents are sent back to the salesperson. The salesperson can then print the authorized contract.

Once sales proposal 122 is accepted and sales contract 128 is generated, contract generator program 126 executes a command to 224 update or create data in customer information database 116 that contains specifics of customer sales contract 128. This allows other applications to access the same data that was agreed upon in the sales contract for additional business processes, such as automating billing and invoicing the customer.

A salesperson puts the terms and conditions negotiated with the customer into writing by using a sales proposal document generated by proposal generator program 118. Traditionally, salespersons have their own preferred methods of creating sales proposal documents. They may use a computer that contains word processing software in order to create a sales proposal document, then use existing proposal documents as templates and simply change the terms, conditions, and other customer-specific information for subsequent proposals. Regardless of the method used for generating sales proposal documents, salespersons often end up spending unnecessary time performing rework on each proposal document. What is needed is a way to decrease the time it takes for a salesperson to generate a sales proposal document. The embodiments may overcome these difficulties by providing an automated system whereby key terms associated with sales policies are automatically inserted into the proposal from a local sales policy file.

A sales proposal document may have been generated based on terms and conditions agreed upon by a salesperson and a customer. The proposal terms may need to be verified by an authorizing entity, such as a sales manager. As sales managers rarely travel with the sales force, the proposal document is sent to the manager from the salesperson's remote location, reviewed, and sent back to the salesperson. Because salespersons and sales managers each often have their own preferred formats and methods of creating and editing sales proposals documents, the salesperson often must add the manager's changes to the proposal document, especially if changes are returned in a hard-copy format, such as facsimile, or in a soft-copy format other than that used by the salesperson to create the proposal document. The embodiment discloses a consistent format used by both the sales force and sales managers that allows for quick and consistent transfer among both entities.

Furthermore, once a sales proposal document becomes an official sales contract, the agreed-upon terms and conditions inside the sales contract become valuable information that are often utilized by other processes within the business. An example includes using billing terms as agreed upon in the contract by the company's billing department to accurately charge the customer. As previously discussed, most traditional formats for sales proposal documents and contracts, such as a word processing document, are not conducive to data sharing. As a result, another user may take each sales contract and perform data entry with the contract information into other applications. This duplicates the work previously done by the salesperson and sales manager when establishing the contract. Additionally, the salesperson might offer something in the contract that another business process is not currently set up to handle. One common example is a software feature that is not currently ready for selling or is no longer supported. Consequently, until the sales proposal document is shared with other necessary parties, an information disconnect may exist between the sale and what is actually being provided. The disclosure further overcomes these traditional problems by using methods and systems that take the information contained within each sales contract and effortlessly sharing the data with other processes that need this information.

The various techniques, methods, and aspects of the disclosure described herein can be implemented in part or in whole using computer-based systems and methods. Additionally, computer-based systems and methods can be used to augment or enhance the functionality described above, increase the speed at which the functions can be performed, and provide additional features and aspects as a part of, or in addition to, those of the disclosure described elsewhere in this document. Various computer-based systems, methods and implementations in accordance with the above-described technology are presented below.

A processor-based system for carrying out a method of the disclosure can include a main memory, typically random access memory (RAM), and can also include a secondary memory. The secondary memory can include, for example, a hard disk drive and/or a removable storage drive, representing a floppy disk drive, a magnetic tape drive, an optical disk drive, and the like. The removable storage drive reads from and/or writes to a removable storage medium. Removable storage medium refers to a floppy disk, magnetic tape, optical disk, and the like, which is read by, and written to by, a removable storage drive. As will be appreciated, the removable storage medium can comprise computer software and/or data.

In alternative embodiments, the secondary memory may include other similar means for allowing computer programs or other instructions to be loaded into a computer system. Such means can include, for example, a removable storage unit and an interface. Examples of such can include a program cartridge and cartridge interface (such as the found in video game devices), a movable memory chip (such as an EPROM or PROM) and associated socket, and other removable storage units and interfaces, which allow software and data to be transferred from the removable storage unit to the computer system.

The computer system can also include a communications interface. Communications interfaces allow software and data to be transferred between a computer system and external devices. Examples of communications interfaces can include a modem, a network interface (such as, for example, an Ethernet card), a communications port, a PCMCIA slot and card, and the like. Software and data transferred via a communications interface are in the form of signals, which can be electronic, electromagnetic, optical or other signals capable of being received by a communications interface. These signals are provided to communications interface via a channel capable of carrying signals and can be implemented using a wireless medium, wire or cable, fiber optics or other communications medium. Some examples of a channel can include a phone line, a cellular phone link, an RF link, a network interface, and other communications channels.

A computer program medium and computer usable medium are used to refer generally to media such as a removable storage device, a disk capable of installation in a disk drive, and signals on a channel. These computer program products are means for providing software or program instructions to a computer system.

Computer programs (sometimes referred to as computer control logic) are stored in main memory and/or secondary memory. Computer programs can also be received via a communications interface. Such computer programs, when executed, enable the computer system to perform the features of the disclosure as discussed herein. In particular, the computer programs, when executed, enable the processor to perform the features of the disclosure. Accordingly, such computer programs represent controllers of the computer system.

In an embodiment where the elements are implemented using software, the software may be stored in, or transmitted via, a computer program product and loaded into a computer system using a removable storage drive, hard drive or communications interface. The control logic (software), when executed by the processor, causes the processor to perform the functions of the disclosure as described herein.

In another embodiment, the elements are implemented primarily in hardware using, for example, hardware components such as PALs, application specific integrated circuits (ASICs) or other hardware components. Implementation of a hardware state machine so as to perform the functions described herein will be apparent to person skilled in the relevant art(s). In yet another embodiment, elements are implanted using a combination of both hardware and software.

In another embodiment, the computer-based methods can be accessed or implemented over the World Wide Web by providing access via a Web Page to the methods of the disclosure. Accordingly, the Web Page is identified by a Universal Resource Locator (URL). The URL denotes both the server machine and the particular file or page on that machine. In this embodiment, it is envisioned that a consumer or client computer system interacts with a browser to select a particular URL, which in turn causes the browser to send a request for that URL or page to the server identified in the URL. Typically the server responds to the request by retrieving the requested page and transmitting the data for that page back to the requesting client computer system (the client/server interaction is typically performed in accordance with the hypertext transport protocol (“HTTP”)). The selected page is then displayed to the user on the client's display screen. The client may then cause the server containing a computer program of the disclosure to launch an application to, for example, perform an analysis according to the disclosure.

A number of embodiments of the invention have been described. Nevertheless, it will be understood that various modifications may be made without departing from the spirit and scope of the invention. Accordingly, other embodiments are within the scope of the following claims.

What is claimed is:

1. A method, comprising:
storing a local sales policy information file to include at least one current sales policy;
generating a sales proposal based on at least a customer information and the local sales policy information file;
providing the sales proposal to a central sales client;
generating a sales contract based upon the sales proposal; and
updating a central database with the customer information and with local sales policy information from said information file.

2. The method of claim 1, wherein the current sales policy are stored at a remote location.

3. The method of claim 2, wherein the remote location is the central sales client.

4. The method of claim 1, wherein the central database is accessed by a plurality of other clients.

5. The method of claim 4, wherein the plurality of other clients comprises an accounting client.

6. The method of claim 1, wherein the at least one customer information is selected from the group consisting of payment terms, payment mode, bank payment data, delivery terms, taxes, product delivery mode, vendor's warehouse location, term of proposal delivery, term of contract validity and a combination thereof.

7. The method of claim 1, wherein the at least one current sales policy is selected from the group consisting of a minimum sales policy, a contract period, delivery time periods, and a combination thereof.

8. A method as in claim 1, wherein said storing, generating a proposal, providing a sales proposal, generating a sales contract and updating a central database are carried out by a computer.

9. A computer program on computer readable medium which, when executed, cause a computer to:
update a local sales policy information file to include at least one current sales policy from a master sales policy file;
generate a sales proposal based on at least a customer information and the local sales policy information file;
provide the sales proposal to a central sales client;
generating a sales contract based upon the sales proposal; and
update a central database with the customer information and with local sales policy information from said information file.

10. The computer program of claim 9, wherein the current sales policy are stored at a remote location.

11. The computer program of claim 10, wherein the remote location is the central sales client.

12. The computer program of claim 9, wherein the central database is accessed by a plurality of other clients.

13. The computer program of claim 12, wherein the plurality of other clients comprises an accounting client.

14. The computer program of claim 9, wherein the at least one customer information is selected from the group consisting of payment terms, payment mode, bank payment data, delivery terms, taxes, product delivery mode, vendor's warehouse location, term of proposal delivery, term of contract validity and a combination thereof.

15. The computer program of claim 9, wherein the at least one current sales policy is selected from the group consisting of a minimum sales policy, a contract period, delivery time periods, and a combination thereof.

16. A system, comprising:
at least one first computer comprising
a local sales policy file;
a proposal generator program executed on the first computer to generate a proposal based on said local sales policy file;
at least one second computer comprising
a master sales policy file;
a contract generator program executed on the second computer to generate a contract based on said local master sales policy file and the proposal;
a communication network sending and receiving information from the at least one first computer and the at least one second computer; and
a customer database,
wherein the at least one first computer comprises a computer program with instructions which, when executed, cause the computer to:
update the local sales policy information file with at least one current sales policy from a master sales policy file on the second computer; and
generate a sales proposal based on a customer information and the local sales policy information file;
provide the sales proposal to the at least one second computer;
wherein the at least one second computer comprises a computer program to cause the computer to:
generate a sales contract based upon the sales proposal; and
update the central database with the customer information and local sales policy information of the sales contract.
